(19) United States
(12) Patent Application Publication
(10) Pub. No.: US 2013/0154913 A1
(43) Pub. Date: Jun. 20, 2013

(54) SYSTEMS AND METHODS FOR A GAZE AND GESTURE INTERFACE

(71) Applicants: Yakup Genc, Dayton, NJ (US); Jan Ernst, Plainsboro, NJ (US); Stuart Goose, Berkeley, CA (US); Xianjun S. Zheng, Plainsboro, NJ (US)

(72) Inventors: Yakup Genc, Dayton, NJ (US); Jan Ernst, Plainsboro, NJ (US); Stuart Goose, Berkeley, CA (US); Xianjun S. Zheng, Plainsboro, NJ (US)

(73) Assignee: Siemens Corporation, Iselin, NJ (US)

(21) Appl. No.: 13/325,361

(22) Filed: Dec. 14, 2011

Related U.S. Application Data
(60) Provisional application No. 61/423,701, filed on Dec. 16, 2010.
(60) Provisional application No. 61/537,671, filed on Sep. 22, 2011.

(51) Int. Cl. G06F 3/01

(52) U.S. Cl. CPC G06F 3/011
USPC 345/156

(57) ABSTRACT

A system and methods for activating and interacting by a user with at least a 3D object displayed on a 3D computer display by at least the user's gestures which may be combined with a user's gaze at the 3D computer display. In a first instance the 3D object is a 3D CAD object. In a second instance the 3D object is a radial menu. A user's gaze is captured by ahead frame containing at least an endo camera and an exo camera worn by a user. A user's gesture is captured by a camera and is recognized from a plurality of gestures. User's gestures are captured by a sensor and are calibrated to the 3D computer display.

### STATEMENT OF RELATED CASES

The present application claims priority to and the benefit of U.S. Provisional Patent Application Ser. No. 61/423,701 filed on Dec. 16, 2010, and of U.S. Provisional Patent Application Ser. No. 61/537,671 filed on Sep. 22, 2011.

### TECHNICAL FIELD

The present invention relates to activating of and interacting with 3D objects displayed on a computer display by a user's gaze and gesture.

### BACKGROUND

3D technology has become more available. 3D TVs have recently become available. 3D video games and movies are starting to become available. Computer Aided Design (CAD) software users are starting to use 3D models. Current interactions of designers with 3D technologies, however, are of a traditional nature, using classical entry devices such as a mouse, tracking ball and the like. A formidable challenge is to provide natural and intuitive interaction paradigms that facilitate a better and faster use of 3D technologies.

Accordingly, improved and novel systems and methods for using 3D interactive gaze and gesture interaction with a 3D display are required.

### SUMMARY

In accordance with an aspect of the present invention, methods and systems are provided to allow a user to interact with a 3D object through gazes and gestures. In accordance with an aspect of the invention, the gaze interface is provided by a headframe with one or more cameras worn by a user. Methods and apparatus are also provided to calibrate a frame worn by a wearer containing an exo-camera directed to a display and a first and a second endo-camera, each directed to an eye of the wearer.

In accordance with an aspect of the present invention a method is provided for a person wearing a head frame having a first camera aimed at an eye of the person to interact with a 3D object displayed on a display by gazing at the 3D object with the eye and by making a gesture with a body part, comprising sensing an image of the eye, an image of the display and an image of the gesture with at least two cameras, one of the at least two cameras being mounted in the head frame adapted to be pointed at the display and the other of the at least two cameras being the first camera, transmitting the image of the eye, the image of the gesture and the image of the display to a processor, the processor determining a viewing direction of the eye and a location of the head frame relative to the display from the images and then determining the 3D object the person is gazing at, the processor recognizing the gesture from the image of the gesture out of a plurality of gestures, and the processor further processing the 3D object based on the gaze or the gesture or the gaze and the gesture.

In accordance with a further aspect of the present invention a method is provided, wherein the second camera is located in the head frame.

In accordance with yet a further aspect of the present invention a method is provided, wherein a third camera is located either in the display or in an area adjacent to the display.

In accordance with yet a further aspect of the present invention a method is provided, wherein the head frame includes a fourth camera in the head frame pointed at a second eye of the person to capture a viewing direction of the second eye.

In accordance with yet a further aspect of the present invention a method is provided, further comprising the processor determining a 3D focus point from an intersection of the first eye's viewing direction and the second eye's viewing direction.

In accordance with yet a further aspect of the present invention a method is provided, wherein the further processing of the 3D object includes an activation of the 3D object.

In accordance with yet a further aspect of the present invention a method is provided, wherein the further processing of the 3D object includes a rendering with an increased resolution of the 3D object based on the gaze or the gesture or both the gaze and the gesture.

In accordance with yet a further aspect of the present invention a method is provided, wherein the 3D object is generated by a Computer Aided Design program.

In accordance with yet a further aspect of the present invention a method is provided, further comprising the processor recognizing the gesture based on the data from the second camera.

In accordance with yet a further aspect of the present invention a method is provided, wherein the processor moves the 3D object on the display based on the gesture.

In accordance with yet a further aspect of the present invention a method is provided, further comprising the processor determining a change in position of the person wearing the head frame to a new position and the processor re-rendering the 3D object on the computer 3D display corresponding to the new position.

In accordance with yet a further aspect of the present invention a method is provided, wherein the processor determines the change in position and re-renders at a frame rate of the display.

In accordance with yet a further aspect of the present invention a method is provided, further comprising the processor displaying information related to the 3D object being gazed at.

In accordance with yet a further aspect of the present invention a method is provided, wherein the further processing of the 3D object includes an activation of a radial menu related to the 3D object.

In accordance with yet a further aspect of the present invention a method is provided, wherein further processing of the 3D object includes an activation of a plurality of radial menus stacked on top of each other in 3D space.

In accordance with yet a further aspect of the present invention a method is provided, further comprising the processor calibrating a relative pose of a hand and atm gesture of the person pointing at an area on the 3D computer display, the person pointing at the 3D computer display in a new pose and the processor estimating coordinates related to the new pose based on the calibrated relative pose.

In accordance with another aspect of the present invention a system is provided wherein a person interacts with one or more of a plurality of 3D objects through a gaze with a first eye and through a gesture by a body part, comprising a computer display that displays the plurality of 3D objects, a head frame containing a first camera adapted to point at the first eye of the person wearing the head frame and a second camera adapted to point to an area of the computer display and to capture the gesture, a processor, enabled to execute instructions to perform the steps: receiving data transmitted by the first and second cameras, processing the received data to determine a 3D object in the plurality of objects where the gaze is directed at, processing the received data to recognize the gesture from a plurality of gestures and further processing the 3D object based on the gaze and gesture.

In accordance with yet another aspect of the present invention a system is provided, wherein the computer display displays a 3D image.

In accordance with yet another aspect of the present invention a system is provided, wherein the display is part of a stereoscopic viewing system.

In accordance with a further aspect of the present invention a device is provided with which a person interacts with a 3D object displayed on a 3D computer display through a gaze from a first eye and a gaze from a second eye and through a gesture by a body part of a person, comprising a frame adapted to be worn by the person, a first camera mounted in the frame adapted to point at the first eye to capture the first gaze, a second camera mounted in the frame adapted to point at the second eye to capture the second gaze, a third camera mounted in the frame adapted to point at the 3D computer display and to capture the gesture, a first and a second glass mounted in the frame such that the first eye looks through the first glass and the second eye looks through the second glass, the first and second glasses acting as 3D viewing shutters and a transmitter to transmit data generated by the cameras.

### DRAWINGS

FIG. 1 is an illustration of a video-see-through calibration system;

FIGS. 2 to 4 are images of a head-worn-multi-camera system that is used in accordance with an aspect of the present invention;

FIG. 5 provides a model of an eyeball with regard to an endo-camera in accordance with an aspect of the present invention;

FIG. 6 illustrates a one step calibration step that can be used after the initial calibration is performed; and

FIG. 7 illustrates the use of an Industry Gaze and Gesture Natural Interface system in accordance with an aspect of the present invention;

FIG. 8 illustrates an Industry Gaze and Gesture Natural Interface system in accordance with an aspect of the present invention;

FIGS. 9 and 10 illustrate gestures in accordance with an aspect of the present invention;

FIG. 11 illustrates a pose calibration system in accordance with an aspect of the present invention; and

FIG. 12 illustrates a system in accordance with an aspect of the present invention.

### DESCRIPTION

Aspects of the present invention relate to or depend on a calibration of a wearable sensor system and on registration of images. Registration and/or calibration systems and methods are disclosed in U.S. Pat. Nos. 7,639,101; 7,190,331 and 6,753,828. Each of these patents is hereby incorporated by reference.

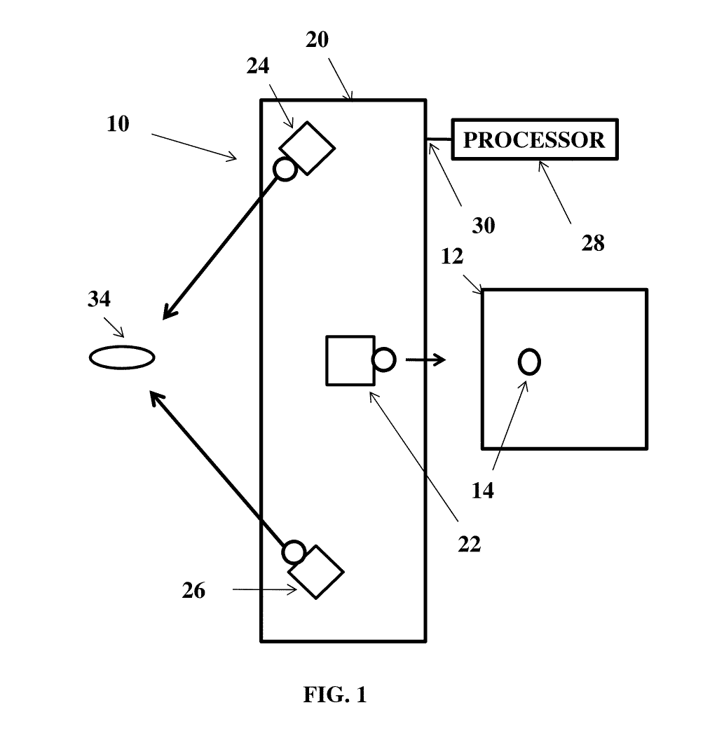

First, methods and systems for calibration of a wearable multi-camera system will be described. FIG. 1 illustrates a head worn, multi camera eye tracking system. A computer display 12 is provided. A calibration point 14 is provided at various locations on the display 12. A head worn, multi-camera device 20 can be a pair of glasses. The glasses 20 include an exo-camera 22, a first endo-camera 24 and a second endo-camera 26. Images from each of the cameras 22, 24 and 26 are provided to a processor 28 via output 30. The endo-cameras 24 and 26 are aimed at a user's eye 34. The endo camera 24 is aimed away from the user's eye 34. During calibration in accordance with an aspect of the present invention the endo-camera is aimed toward the display 12.

Next a method for geometric calibration of head-worn multi-camera eye tracking system as shown in FIG. 1 in accordance with an aspect of the present invention will be described

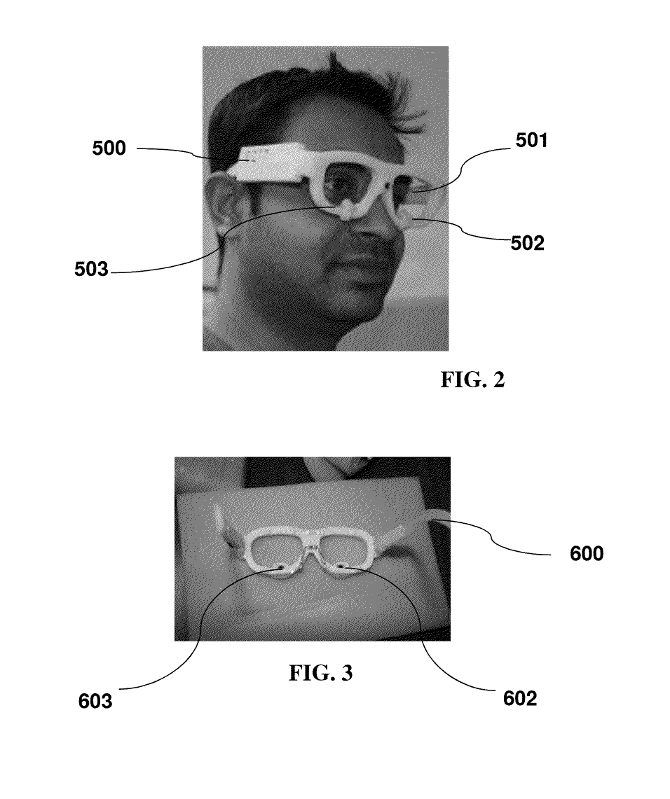

An embodiment of the glasses 20 is shown in FIGS. 2-4. A frame with endo and exo cameras is shown in FIG. 2. Such a frame is available from Eye-Com Corporation in Reno, Nev. The frame 500 has an exo-camera 501 and two endo-cameras 502 and 503. While the actual endo-cameras are not visible in FIG. 2, the housings of the endo-cameras 502 and 503 are shown. An internal view of a similar but newer version of a wearable camera set is shown in FIG. 3. The endo-cameras 602 and 603 in the frame 600 are clearly shown in FIG. 3. FIG. 4 shows a wearable camera 700 with exo camera and endo cameras connected through a wire 702 to a receiver of video signals 701. Unit 701 may also contain a power source for the camera and a processor 28. Alternatively, the processor 28 can be located anywhere. In a further embodiment of the present invention video signals are transmitted wirelessly to a remote receiver.

It is desired to accurately determine where a wearer of the head-worn camera is looking. For instance, in one embodiment a wearer of the head-worn camera is positioned between about 2 feet and 3 feet, or between 2 feet and 5 feet, or between 2 feet and 9 feet away from a computer screen which may include a keyboard, and in accordance with an aspect of the present invention, the system determines coordinates in calibrated space where the gaze of the wearer is directed at on the screen or on the keyboard or elsewhere in a calibrated space.

As already described, there are two sets of cameras. The exo-camera 22 relays information about the pose of the multi-camera system with respect to the world, and the endo-cameras 24 and 26 relay information about the pose of the multi-camera system with respect to the user and the sensor measurements for estimating the geometric model.

Several methods of calibrating the glasses are provided herein. The first method is a two step process. The second method of calibration relies on the two step process and then uses a homography step. The third method of calibration processes the two steps at the same time rather than at separate times.

Method 1—Two Step

The method 1 commences system calibration in two consecutive steps, namely endo-exo and endo-eye calibration.

First Step of Method 1: Endo-Exo Calibration

With the help of two disjoint calibration pattern, i.e. fixed points in 3D with precisely known coordinates, a set of exo- and endo-camera frame pairs are collected and the projections of the 3D-positions of the known calibration points are annotated in all images. In an optimization step, the relative pose of each exo- and endo-camera pair is estimated as the set of rotation and translation parameters minimizing a particular error criterion.

The endo-exo calibration is performed per eye, i.e. once on the left eye and then again on the right eye separately.

In the first step of method 1, the relative transformation between endo camera coordinate system and exo camera coordinate system is established. In accordance with an aspect of the present invention, the parameters R^{ex}, t^{ex} in the following equation are estimated:

p^{x}=R^{ex}p^{e}+t^{ex}

where
R^{ex}εSO(3) is a rotation matrix, wherein SO(3) is the rotation group as known in the art,
t^{ex}εR³ is a translation vector between the endo and exo camera coordinate system,
p^{x}εR³ is a point in the exo camera coordinate system,
p^{x}εR³ is a vector of points in the exo camera coordinate system,
p^{e}εR³ is a point in the endo camera coordinate system, and
p^{e}εR³ is a vector of points in the endo camera coordinate system.

In the following, the pair R^{ex}, t^{ex} is consumed in the homogeneous matrix T^{ex}εR⁴×R⁴ which is constructed from R^{ex} via Rodrigues' formula and concatenation of t^{ex}. The matrix T^{ex} is called a transformation matrix for homogeneous coordinates. The matrix T^{ex} is constructed as follows:

$${T}^{ex} = [ \begin{matrix} & {R}^{ex} & & {t}^{ex} \\ 0 & 0 & 0 & 1\end{matrix} ] ,$$

which is a concatenation of t^{ex} and [0 0 0 1]^{T}, which is a standard textbook procedure.

The (unknown) parameters of T^{ex} are estimated as \tilde{T}^{ex} by minimizing an error criterion as follows:

1. Two disjoint (i.e. not rigidly coupled) calibration reference grids G^{e}, G^{x} have M markers applied at precisely known locations spread in all three dimensions;
2. The grids G^{e}, G^{x} are placed around the endo-exo camera system such that G^{x} is visible in the exo camera image and G^{e} is visible in the endo camera image;
3. An exposure each of endo and exo camera is taken;
4. The endo and exo camera system is rotated and translated into a new position without moving the grids G^{e}, G^{x} such that the visibility condition in step 2 above is not violated;
5. Steps 3 and 4 are repeated until N (double, i.e. exo/endo) exposures are taken.
6. In each of the N exposures/images and for each camera (endo, exo) the imaged locations of the markers are annotated, resulting in the M×N marked endo image locations l_{n,m}^{e}εR² and the M×N marked exo image locations l_{n,m}^{x}εR².
7. For each of the N exposures/images and for each camera (endo, exo) the external pose matrices Tₙ^{e}εR⁴×R⁴ and Tₙ^{x}εR⁴×R⁴ are estimated from the marked image locations of step 6 and their known groundtruth from step 1 via an off-the-shelf external camera calibration module.
8. The optimization criterion is derived by looking at the following equation transforming a world point p^{e} in the endo grid G^{e} coordinate system into the point p^{x} in the exo grid G^{x} coordinate system: p^{x}=Gp^{e}, where G is the unknown transformation from the endo to the exo grid coordinate system. Another way to write this is:

p^{x}=(Tₙ^{x})⁻¹T^{ex}Tₙ^{e}p^{e} ∀n (1)

In other words the transformation (Tₙ^{x})⁻¹T^{ex}Tₙ^{e} is the unknown transformation between the two grid coordinate systems. The following follows directly: \tilde{T}^{ex} is a correct estimate of T^{ex} if all points {p^{e}} are always transformed via equation 1 into the same points {p^{x}} for all N instances (T^{x},T^{e})ₙ.

Consequently the error/optimization/minimization criterion is posed in a fashion that it favors \tilde{T}^{ex} where the resulting p^{x} are close together for each member of the set {p^{x}}, such as the following:

σ²=Σ[{Var(p^{x})}], pₙ^{x}=(Tₙ^{x})⁻¹\tilde{T}^{ex}Tₙ^{e}p^{e}. (2)

These steps just described are performed for the pair of cameras 22 and 24 and for the pair of cameras 22 and 26.

Second Step of Method 1: Endo-Eye Calibration

Next, an endo-eye calibration is performed for each calibration pair determined above. In accordance with an aspect of the present invention, the endo-eye calibration step consists of estimating the parameters of a geometric model of the human eye, its orientation and the position of the center location. This is performed after the endo-exo calibration is available by collecting a set of sensor measurements comprising the pupil center from the endo-cameras and the corresponding external pose from the exo-camera while the user focuses on a known location in the 3D screen space.

An optimization procedure minimizes the gaze re-projection error on the monitor with regard to the known ground truth.

The purpose is to estimate the relative position of the eyeball center cεR³ in the endo eye camera coordinate system and the radius r of the eyeball. The gaze location on a monitor is calculated in the following fashion given the pupil center l in the endo eye image:

The steps include:

1. Determine the intersection point a of the projection of l into world coordinates with the eyeball surface;
2. Determine the direction of gaze in the endo camera coordinate system by the vector a-c;
3. Transform the direction of gaze from step 2 into the exo world coordinate system by the transformation obtained/estimated in the earlier section;
4. Establish the transformation between the exo camera coordinate system and a monitor by e.g. a marker tracking mechanism;
5. Determine the intersection point d of the vector from step 3 with the monitor surface given the estimated transformation of step 4.

The unknowns in the calibration step are the eyeball center c and the eyeball radius r. They are estimated by gathering K pairs of screen intersection points d and pupil centers in the endo image l: (d; l)ₖ. The estimated parameters \tilde{c} and \tilde{r} are determined by minimizing the reprojection error of the estimated \tilde{d} versus the actual ground truth locations d, e.g.

min E(|d−\tilde{d}|) (3)

with some metric E. The sought eyeball center \tilde{c} and eyeball radius \tilde{r} estimates then are the ones that minimize equation 3.

The ground truth is provided by predetermined reference points, for instance as two different series of points with one series per eye, that are displayed on a known coordinate grid of a display. In one embodiment the reference points are distributed in a pseudo-random fashion over an area of the display. In another embodiment the reference points are displayed in a regular pattern.

The calibration points are preferably distributed in a uniform or substantially uniform manner over the display to obtain a favorable calibration of the space defined by the display. The use of a predictable or random calibration pattern may depend on a preference of a wearer of the frame. However, preferably, all the points in a calibration pattern should not be co-linear.

A system as provided herein preferably uses at least or about 12 calibration points on the computer display. Accordingly, at least or about 12 reference points in different locations for calibration are displayed on the computer screen. In a further embodiment more calibration points are used. For instance at least 16 points or at least 20 points are applied. These points may be displayed at the same time, allowing the eye(s) to direct the gaze to different points. In a further embodiment fewer than twelve calibration points are used. For instance, in one embodiment two calibration points are used. Selection of the number of calibration points is in one aspect based on the convenience or comfort of the user, wherein a high number of calibration points may form a burden to the wearer. A very low number of calibration points may affect the quality of use. It is believed that a total number of 10-12 calibration points in one embodiment is a reasonable number. In a further embodiment only one point at a time is displayed during calibration.

Method 2—Two Step and Homography

The second method uses the two steps above and a homography step. This method uses method 1 as an initial processing step and improves the solution by estimating an additional homography between the estimated coordinates in the screen world space from method 1 and the ground truth in the screen coordinate space. This generally addresses and diminishes systematic biases in the former estimation, thus improving the re-projection error.

This method is based on the estimated variables of method 1, i.e. it supplements method 1. After the calibration steps in section 1 have commenced, there is typically a residual error in the projected locations \tilde{d} versus the true locations d. In a second step this error is minimized by modeling the residual error as a homography H, i.e. d=H\tilde{d}. The homography is readily estimated by standard methods with the set of pairs (d, \tilde{d}) of the previous section and then applied to correct for the residual error. Homography estimation is for instance described in U.S. Pat. No. 6,965,386 to Appel et al issued on Nov. 15, 2005 and U.S. Pat. No. 7,321,386 to Mittal et al. issued on Jan. 22, 2008 which are both incorporated herein by reference.

Homography is known to one of ordinary skill and is described for instance in Richard Hartley and Andrew Zisserman: “Multiple View Geometry in Computer Vision”, Cambridge University Press, 2004.

Method 3—Joint Optimization

This method addresses the same calibration problem by jointly optimizing the parameters of the endo-exo and the en do-eye space at the same time rather than individually. The same reprojection error of the gaze direction in the screen space is used. The optimization of the error criterion proceeds over the joint parameter space of the endo-exo as well as the endo-eye geometry parameters.

This method treats the endo-exo calibration as described above as part of method 1 as well as the endo-eye calibration as described above as part of method 1 jointly as one optimization step. The basis for optimization is the monitor reprojection error criterion in equation (3). The estimated variables specifically are T^{ex}; c and r. Their estimates \tilde{T}^{ex}, \tilde{c} and \tilde{r} are the solutions to minimizing the reprojection error criterion as output from any off-the-shelf optimization method.

Specifically this entails:

1. Given a set of known monitor intersection points d and the associated pupil center location in the endo image l, i.e. (d, l)ₖ, calculate the reprojection error for the reprojected gaze locations \tilde{d}. The gaze location is reprojected by the method described above related to the Endo-eye calibration.
2. Employ an off-the-shelf optimization method to find the parameters \tilde{T}^{ex}, \tilde{c} and \tilde{r} that minimize the reprojection error of step 1.
3. The estimated parameters \tilde{T}^{ex}, \tilde{c} and \tilde{r} are then the calibration of the system and can be used to reproject a novel gaze direction.

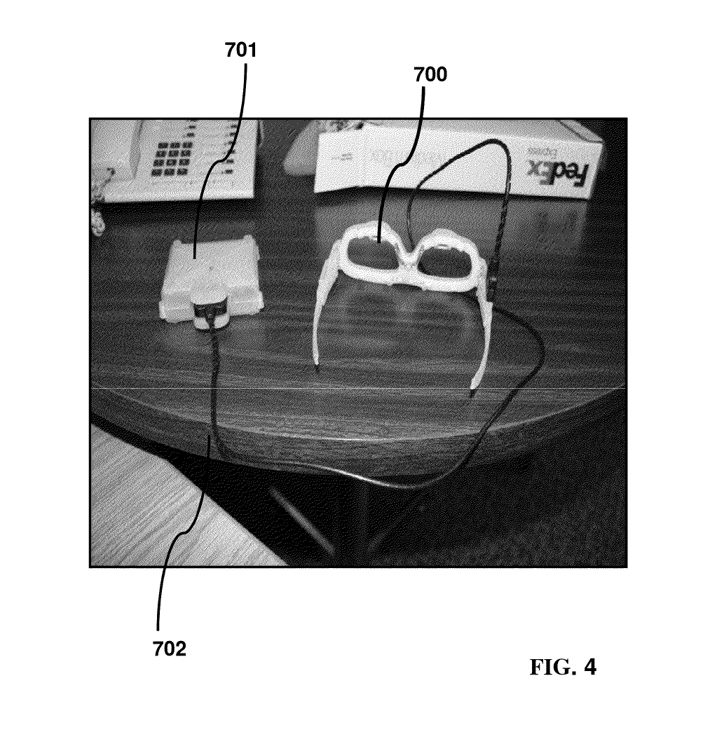

A diagram of a model of an eye related to an endo camera is provided in FIG. 5. It provides a simplified view of the eye geometry. The location of fixation points are compensated at different instances by the head tracking methods as provided herein and are shown at different fixation points dᵢ, dⱼ and dₖ on a screen.

Online One-Point Re-Calibration

One method improves calibration performance over time and enable additional system capabilities, resulting in improved user comfort, including (a) longer interaction time via simple on-line recalibration; and ability to take eye frame off and back on again without having to go through a full recalibration process.

For the on-line recalibration, a simple procedure is initiated as described below to compensate calibration errors such as for accumulative for accumulative calibration errors due frame movement (which may be a moving eye-frame either due to extended wear time or taking the eye frame off and back on, for instance).

Method

The one-point calibration estimates and compensates for a translational bias in screen coordinates between the actual gaze location and the estimated gaze location independently of any previous calibration procedure.

The re-calibration process can be initiated either manually, for instance when the user notices the need for recalibration. e.g. due to lower than normal tracking performance. The re-calibration process can also be initiated automatically, for instance when the system infers from the user's behavioral pattern that the tracking performance is dropping (e.g., if the system is being used to implement typing, a lower than normal typing performance may indicate the need to re-calibrate), or simply after a fixed amount of time.

The one-point calibration occurs after for instance full calibration as described above has been performed. However, as stated before, the one-point calibration is independent of which calibration method was applied.

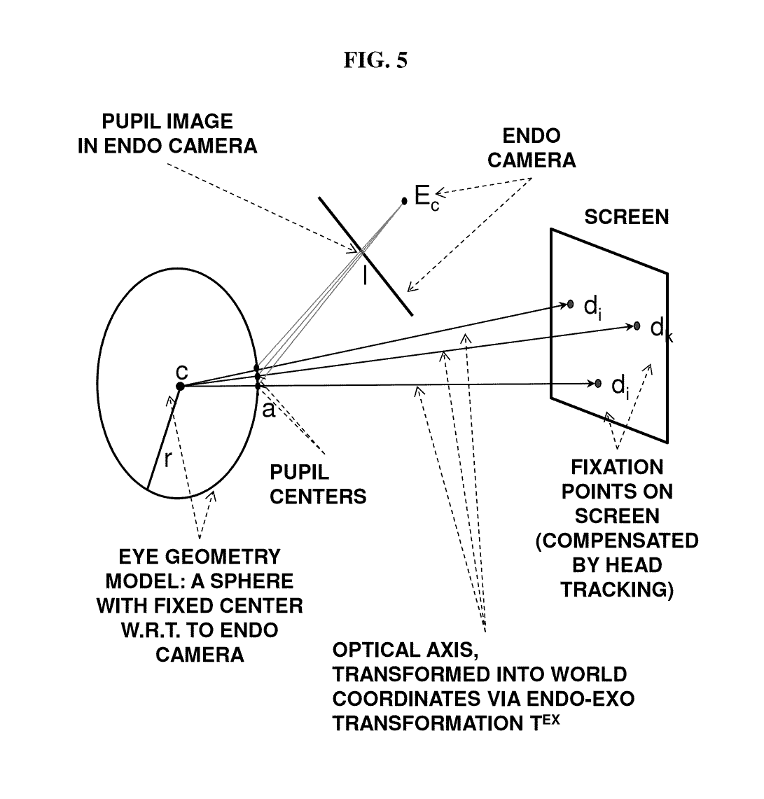

Whenever the online one-point calibration is initiated, referring to FIG. 6, the following steps are performed:

1. Displaying of one visual marker 806 at a known position on the screen 800 (for instance on the screen center);
2. Ensuring that the user fixates on this point (for a cooperative user this can be triggered by a small waiting time after displaying the marker);
3. Determining where the user is gazing with the frames. In the case of FIG. 6, the user is gazing at point 802 along the vector 804. Since the user should be gazing at point 806 along vector 808, there is a vector Δe that can calibrate the system.
4. The next step is determining the vector Δe between the actual known point 806 on-screen location from step 1 and the reprojected gaze direction 802/804 from the system in screen coordinates.
5. Further determinations of where the user is gazing are corrected by the vector Δe.
This concludes the one-point recalibration process. For subsequent estimations of the gaze locations, their on-screen reprojection is compensated by Δe until a new one-point recalibration or a new full calibration is initiated.

Additional points can also be used in this re-calibration step, as needed.

In one embodiment the calibrated wearable camera is used to determine where a gaze of user wearing the wearable camera is directed to. Such a gaze may be a voluntary or determined gaze, for instance directed at an intended object or an intended image displayed on a display. A gaze may also be an involuntary gaze by a wearer who is attracted consciously or unconsciously to a particular object or image.

By providing coordinates of objects or images in a calibrated space the system can be programmed to determine at which image, object or part of an object a wearer of the camera is looking at by associating the coordinates of an object in the calibrated space with the calibrated direction of gaze. The gaze of the user on an object, such as an image on a screen, can thus be used for initiating computer input such as data and/or instructions. For instance images on a screen can be images of symbols such as letters and mathematical symbols. Images can also be representative of computer commands. Images can also be representative of URLs. A moving gaze can also be tracked to draw figures. Accordingly, a system and various methods are provided that enable a user's gaze to be used to activate a computer at least similar to how a user's touch activates a computer touch screen.

In one illustrative example of a voluntary or intentional gaze, the system as provided herein displays a keyboard on a screen or has a keyboard associated with the calibration system. Positions of the keys are defined by the calibration and a system thus recognizes a direction of a gaze as being associated with a specific key that is displayed on a screen in the calibration space. A wearer thus can type letters, words or sentences by directing a gaze at a letter on a keyboard which is for instance displayed on the screen. Confirming a typed letter may be based on the duration of the gaze or by gazing at a confirmation image or key. Other configurations are fully contemplated. For instance, rather than typing letters, words or sentences a wearer may select words or concepts from a dictionary, a list, or a database. A wearer may also select and/or construct formulas, figures, structures and the like by using the system and methods as provided herein.

As an example of an involuntary gaze, a wearer may be exposed to one or more objects or images in the calibrated vision space. One may apply the system to determine which object or image attracts and potentially holds the attention of a wearer who has not been instructed to direct a gaze.

SIG²N

In an application of a wearable multi-camera system methods and systems called SIG²N or SIG2N (Siemens Industry Gaze & Gesture Natural interface) are provided that enables a CAD designer to:

1. View their 3D CAD software objects on a real 3D display
2. Use natural gaze & hands gestures and actions to interact directly with their 3D CAD objects resize, rotate, move, stretch, poke, etc.)
3. Use their eyes for various additional aspects of control and to view additional metadata about the 3D object in close proximity.

SIG2N

3D TVs are starting to become affordable for consumers for enjoying viewing 3D movies. In addition, 3D video computer games are starting to emerge, and 3D TVs and computer displays are a good display device for interacting with such games.

For many years, 3D CAD designers have been using CAD software to design new complex products using conventional 2D computer displays, which inherently limits designers' 3D perception and 3D object manipulation & interaction. The advent of this affordable hardware raises the possibility for CAD designers to view their 3D CAD objects in 3D. One aspect of the SIG2N architecture is responsible for converting the output of the Siemens CAD product such that it can be rendered effectively on the 3D TV or 3D computer display.

There is a distinction between a 3D object and how the 3D object is displayed. An object is 3D if it has three-dimensional properties that are displayed as such. For instance an object such as a CAD object is defined with three dimensional properties. In one embodiment of the present invention it is displayed in a 2D manner on a display, hut with an impression or illusion of 3D by providing lighting effects such as shadows from a virtual light source that provides the 2D image an illusion of depth.

To be perceived in 3D or a stereoscopic manner by a human viewer, two images have to be provided by a display of an object reflecting the parallax experienced by using two human sensors (two eyes about 5-10 cm apart) that allows the brain to combine two separate images into one 3D image perception. There are several known and different 3D display technologies. In one technology two images are provided at the same time of a single screen or display. The images are separated by providing each eye with a dedicated filter that passes a first image and blocks the second image for the first eye and blocks the first image and passes the second image for the second eye. Another technology is to provide a screen with lenticular lenses that provide each eye of a viewer with different images. Another technology is to provide each eye with a different image by combining a frame with glasses which switches between the two glasses at a high rate and works in concert with a display that displays right and left eye images at the correct rate corresponding to the switching glasses which are known as shutter glasses.

In one embodiment of the present invention the systems and methods provided herein work on 3D objects displayed in a single 2D image on a screen wherein each eye receives the same image. In one embodiment of the present invention the systems and methods provided herein work on 3D objects displayed in at least two images on a screen wherein each eye receives a different image of the 3D object. In a further embodiment the screen or display or equipment that is part of the display is adapted to show different images, for instance by using lenticular lenses or by being adapted to switch rapidly between two images. In yet a further embodiment the screen shows two images at the same time, but glasses with filters allow the separation of two images for a left and a right eye of a viewer.

In yet a further embodiment of the present invention a screen displays a first and a second image intended for a first and a second eye of a viewer in a rapidly changing sequence. The viewer wears a set of glasses with lenses that operate as alternating opening and closing shutters that are switched from transparent to opaque mode in a synchronized way with the display, so that the first eye only sees the first image and the second eye sees the second image. The changing sequence occurs at a speed that leaves the viewer with an impression of an uninterrupted 3D image, which may be a static image or a moving or video image.

A 3D display herein is thus a 3D display system formed by either only the screen or by a combination of a frame with glasses and a screen that allows the viewer to view two different images of an object in such a manner that a stereoscopic effect occurs related to the object for the viewer.

3D TVs or displays in some embodiments require the viewer to wear special glasses in order to experience the 3D visualization optimally. However, other 3D display techniques are also known and applicable herein. It is further noted that a display may also be a projection screen where upon a 3D image is projected.

Given that the barrier for some users of wearing glasses will already have been crossed, the technology further instruments these glasses will no longer be an issue. It is noted that in one embodiment of the present invention irrespective of the applied 3D display technology, a pair of glasses or a wearable head frame as described above and illustrated in FIGS. 2-4 has to be used by a user to apply the methods as described herein in accordance with one or more aspects of the present invention.

Another aspect of the SIG2N architecture requires the 3D TVs to be augmented with wearable multi-camera frame with at least at least two additional small cameras mounted on the frame. One camera is focused on an eyeball of the viewer, while the other camera is focused forwards able to focus on the 3D TV or display and also to capture any forward facing hand gestures. In a further embodiment of the present invention the head frame has two endo-cameras, a first endo-camera focused on the left eyeball of a user and the second endo-camera focused on the right eyeball of a user.

A single endo-camera allows a system to determine where a user's gaze is directed at. The use of two endo-cameras enables the determination of an intersection of the gaze of each eyeball and thus the determination of a point of 3D focus. For instance, a user may be focused on an object that is located in front of a screen or a projection surface. The use of two calibrated endo-cameras allows the determination of a 3D focus point.

The determination of a 3D focus point is of relevance in applications such as 3D transparent image with points of interests at different depth. The intersection point of the gaze of two eyes can be applied to create the proper focus. For instance a 3D medical image is transparent and includes the body of a patient, including the front and the back. By determining the 3D focus point as an intersection of two gazes a computer determines where the user focuses on. In response, for instance when a user focuses on the back such as vertebrae looking through the chest, the computer increases the transparency of the path that may obscure the view of the back image. In another example, an image object is a 3D object such as a house looked upon from the front to the back. By determining the 3D focus point, the computer makes the path of the view that obscures the view to the 3D focus point more transparent. This allows a viewer to “look through walls” in the 3D image by applying the head frame with 2 end-cameras.

In one embodiment of the present invention a camera separate from the head frame is used to capture a user's pose and/or gestures. A separate camera in one embodiment of the present invention is incorporated in or is attached to or is very close to the 3D display, so that a user watching the 3D display is facing the separate camera. A separate camera in a further embodiment of the present invention is located above a user, for instance it is attached to a ceiling. In yet a further embodiment of the present invention a separate camera observes a user from a side of the user while the user is facing the 3D display.

In one embodiment of the present invention several separate cameras are installed and connected to a system. It depends on a pose of a user which camera will be used to obtain an image of a pose of a user. One camera works well for one pose, for instance a camera looking from above on a hand in a horizontal plane that is opened and closed. The same camera may not work for an open hand in a vertical plane that is moved in the vertical plane. In that case a separate camera looking from the side at the moving hand works better.

The SIG²N architecture is designed as a framework on which one can build rich support for both gaze and hand gestures by the CAD designer to naturally and intuitively interact with their 3D CAD objects.

Specifically, the natural human interface to CAD design provided herein with at least one aspect of the present invention includes:

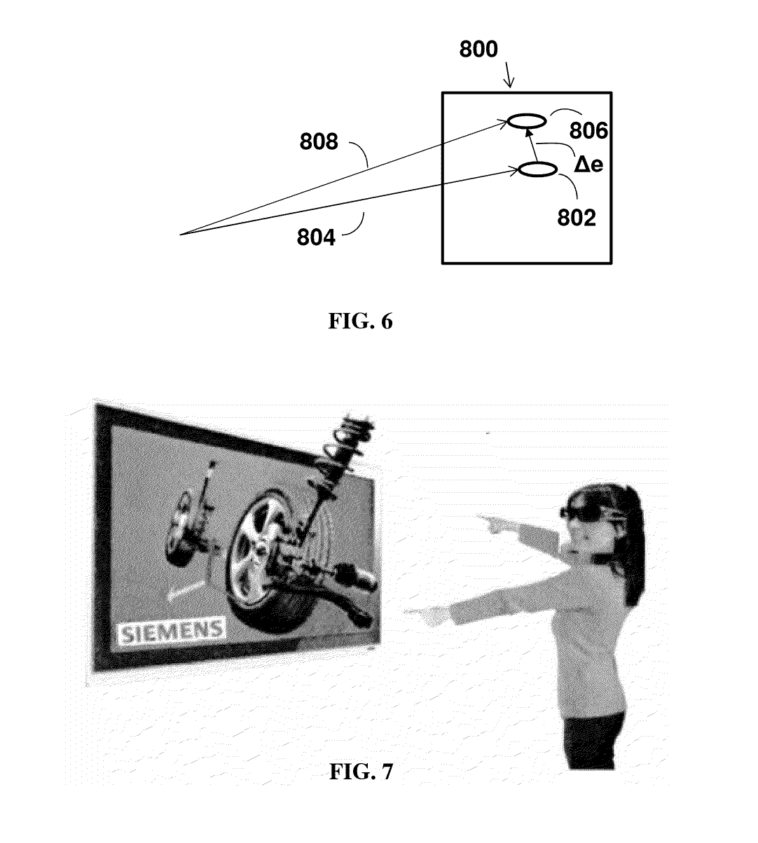

1. Gaze & gesture-based selection & interaction with 3D CAD data (e.g., a 3D object will be activated once the user fixates a gaze at it (“eye-over” effect vs. “mouse-over”), and then the user can directly manipulate the 3D object such as rotating, moving enlarging it by using hand gestures. The recognition of a gesture by a camera as a computer control is disclosed in for instance U.S. Pat. No. 7,095,401 issued to Liu et al. on Aug. 22, 2006 and U.S. Pat. No. 7,095,401 issued to Peter et al. on Mar. 19, 2002, which are incorporated herein by reference. FIG. 7 illustrates at least one aspect of interacting by a user wearing a multi-camera frame with a 3D display. A gesture can be very simple, from a human perspective. It can be static. One static gesture is stretching a flat hand, or pointing a finger. By keeping the pose for a certain time, by lingering in one position, a certain command is affected that interacts with an object on screen. In one embodiment of the present invention a gesture may be a simple dynamic gesture. For instance a hand may be in a flat and stretched position and may be moved from a vertical position to a horizontal position by turning the wrist. Such a gesture is recorded by a camera and recognized by a computer. The hand turning in one example is interpreted in one embodiment of the present invention by a computer as a command to rotate a 3D object displayed on a screen and activated by a user's gaze to be rotated around an axis.

2. Optimized display rendering based on eye gaze location in particular for a large 3D environment. An eye gaze location or an intersection of a gaze of both eyes on an object activates that object, for instance after the gaze lingers for at least a minimum time at one location. The “activation” effect may be a showing of increased detail of the object after it has been “activated” or a rendering of the “activated” object with an increased resolution. Another effect may be the diminishing of resolution of the background or immediate neighborhood of the object, further allowing the “activated” object to stand out.

3. Display object metadata based on eye gaze location to enhance context/situation awareness. This effect occurs for instance after a gaze lingers over an object or after a gaze moves back and forth over an object which activates a label to be displayed related to the object. The label may contain metadata or any other date relevant to the object.

4. Manipulate object or change context by user's location with respect to the perceived 3D object (e.g., head location) which can also be used to render 3D based on the user view point. In one embodiment of the present invention a 3D object is rendered and displayed on a 3D display which is viewed by a user with the above described head frame with cameras. In a further embodiment of the present invention the 3D object is rendered based on the head position of the user relative to the screen. If a user moves, thus moving the position of the frame relative to the 3D display, and the rendered image remains the same, the object will appear to become distorted when viewed by the user from the new position. In one embodiment of the present invention, the computer determines the new position of the frame and the head relative to the 3D display and recalculates and re-draws or renders the 3D object in accordance with the new position. The re-drawing or re-rendering of the 3D image of the object in accordance with an aspect of the present invention takes place at the frame rate of the 3D display.

In one embodiment of the present invention an object is re-rendered from a fixed view. Assume that an object is viewed by a virtual camera in a fixed position. The re-rendering takes place in such a manner that it appears to the user that the virtual camera moves with the user. In one embodiment of the present invention the virtual camera view is determined by the position of the user or the head frame of the user. When the user moves, the rendering is done based on a virtual camera moving relative to the object following the head frame. This allows a user to “walk around” an object that is displayed on a 3D display.

5. Multiple user interaction with multiple eye-frames (e.g., providing multiple view points on the same display for the users).

Architecture

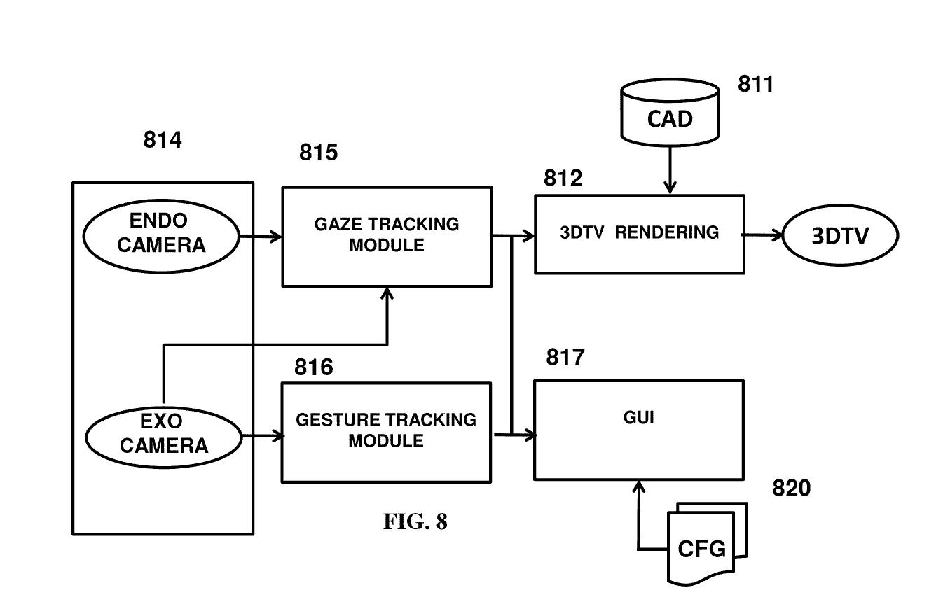

An architecture for a SIG2N architecture with its functional components is illustrated in FIG. 8. The SIG2N architecture includes:

0. A CAD model for instance generated by a 3D CAD design system stored on a storage medium 811.

1. A component 812 to translate CAD 3D object data into 3D TV format for display. This technology is known and is for instance available in 3D monitors, like TRUE3Di's Inc. of Toronto. Canada, which markets a monitor that displays an Autocad 3D model in true 3D on a 3D monitor.

2. 3D TV glasses 814 augmented with cameras and modified calibration and tracking components 815 for gaze tracking calibration and 816 for gesture tracking and gesture calibration (which will be described in detail below). In one embodiment of the present invention the frame as illustrated in FIGS. 2-4 is provided with lenses such as shutter glasses or LC shutter glasses or active shutter glasses as known in the art to view a 3D TV or display. Such 3D shutter glasses are generally optical neutral glasses in a frame wherein each eye's glass contains for instance a liquid crystal layer which has the property of becoming dark when a voltage is applied. By darkening the glasses alternately and in sequence with displayed frames on the 3D display an illusion of a 3D display is created for the wearer of the glasses. In accordance with an aspect of the present invention shutter glasses are incorporated into the head frame with the endo and exo cameras.

3. A gesture recognition component and vocabulary for interaction with CAD models which is part of an interface unit 817. It has been described above that a system can detect at least two different gestures from image data, such as pointing a finger, stretching a hand, rotating the stretched hand between a horizontal and vertical plane. Many other gestures are possible. Each gesture or changes between gestures can have its own meaning. In one embodiment a hand facing a screen in a vertical position can mean stop in one vocabulary and can mean move in a direction away from the hand in a second vocabulary.

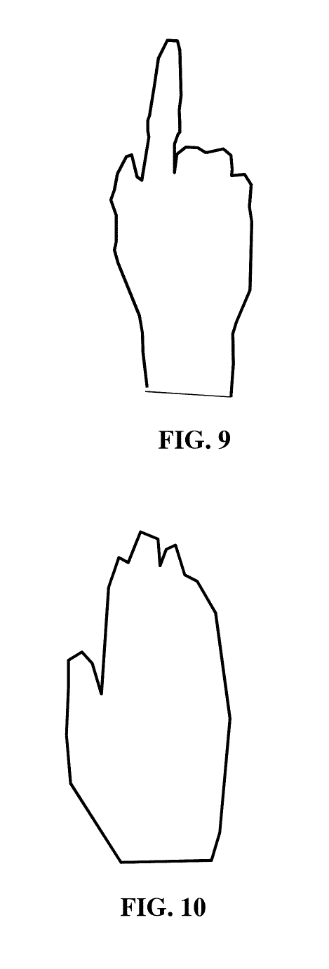

FIGS. 9 and 10 illustrate two gestures or poses of a hand that in one embodiment of the present invention are part of a gesture vocabulary. FIG. 9 illustrates a hand with a pointing finger. FIG. 10 illustrates a flat stretched hand. The gestures or poses of these are recorded by a camera that views an arm with hand from above, for instance. The system can be trained to recognize a limited number of hand poses or gestures from a user. In a simple illustrative gesture recognition system the vocabulary exists of two hand poses. That means that if the pose is not of FIG. 9 it has to be the pose of FIG. 10 and vice versa. Much more complex gesture recognition systems are known.

4. Integration of eye gaze information with the hand gesture events. As described above a gaze may be used to find and activate a displayed 3D object while a gesture may be used to manipulate the activated object. For instance, a gaze on a first object activates it for being able to be manipulated by a gesture. A pointed finger at the activated object that moves makes the activated object follow the pointed finger. In a further embodiment a gaze-over may activate a 3D object while pointing at it may activate a related menu.

5. Eye tracking information to focus the rendering power/latency. The gaze-over may act as a mouse-over that high-lights the gazed at object or increases the resolution or brightness of the gazed-over object.

6. Eye gaze information to render additional metadata in proximity to the CAD object(s). The gaze-over of an object causes the display or listing of text, images or other data related to the gazed-over object or icon.

7. Rendering system with multiple view point capability based on user viewing angle and location. When the viewer wearing the head frame moves the frame relative to the 3D display, the computer calculates the correct rendering of the 3D object to be viewed in an undistorted manner by the viewer. In a first embodiment of the present invention the orientation of the viewed 3D object remains unchanged relative to the viewer with the head frame. In a second embodiment of the present invention the virtual orientation of the viewed object remains unchanged relative to the 3D display and changes in accordance with the viewing position of the user, so that the user can “walk around” the object in half a circle and view it from different points of view.

Other Applications

Aspects of the present invention can be applied to many other environments where the users need to manipulate and interact with 3D objects for diagnosis or developing spatial awareness purposes. For instance, in medical intervention, physicians (e.g., interventional cardiologists or radiologists) often rely on 3D CT/MR model to guidance the navigation of catheter. The Gaze & Gesture Natural Interface as provided herein with an aspect of the present invention will not only provide more accurate 3D perception, easy 3D object manipulation, but also to enhance their spatial control and awareness.

Other applications where 3D data visualization and manipulation play an important role include, for instance:

(a) Building Automation: Building design, automation and management: 3D TVs equipped with SIG2N can play assist in arming the designers, operators, emergency managers and others with intuitive visualization and interaction tools with 3D BIM (building information model) content.

(b) Service: 3D design data along with online sensor data such as videos and ultrasonic signals can be displayed on portable 3D displays on site or service centers. As such usage of Mixed Reality, as it requires intuitive interfaces for gaze and gesture interfaces for hand free operations, would be a good application area for SIG2N.

Gesture Driven Sensor-Display Calibration

An increasing number of applications comprise a combination of optical sensors and one or more display modules (e.g. flat-screen monitors), such as the herein provided SIG2N architecture. This is a particularly natural combination in the domain of vision-based natural user interaction where a user of the system is situated in front of a 2D- or 3D monitor and interacts handsfree via natural gestures with a software application that uses the display for visualization.

In this context it may be of interest to establish the relative pose between the sensor and the display. The herein provided method in accordance with an aspect of the present invention enables the automatic estimation of this relative pose based on hand and arm gesture performed by a cooperative user of the system if the optical sensor system is able to provide metric depth data.

Various sensor systems fulfill this requirement such as optical stereo cameras, depth cameras based on active illumination and time of flight cameras. A further pre-requisite is a module that allows the extraction of hand, elbow and shoulder joints and the head location of a user visible in the sensor image.

Under these assumptions two different methods are provided as aspects of the present invention with the following distinction:

1. The first method assumes that the display dimensions are known.

2. The second method does not need to know the display dimensions.

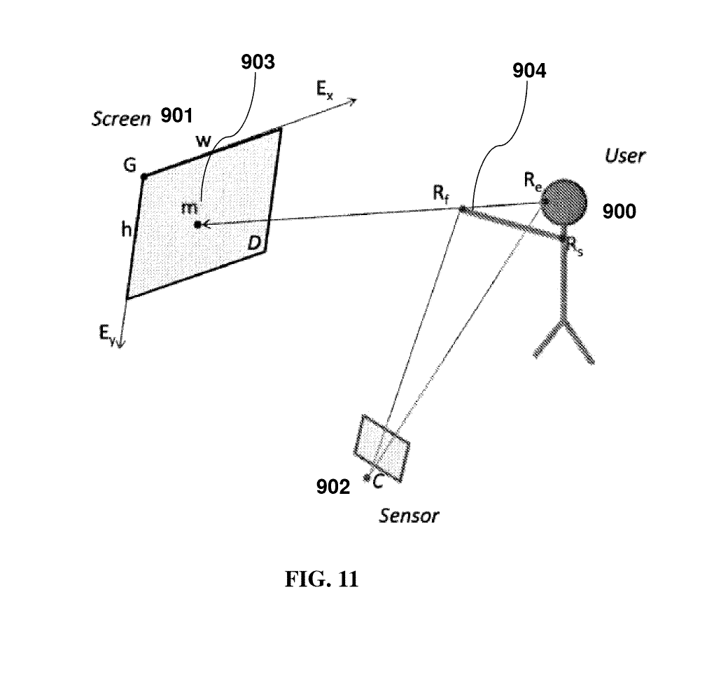

Both methods have in common that a cooperative user 900 as illustrated in FIG. 11 is asked to stand in an upright fashion that he can see the display 901 in a fronto-parallel manner and that he is visible from a sensor 902. Then a set of non-colinear markers 903 is shown on the screen sequentially and the user is asked to point with either left or right hand 904 towards each of the markers when it is displayed. The system automatically determines if the user is pointing by waiting for an extended, i.e. straight, arm. When the arm is straight and not moving for a short time period (≦2 s), the user's geometry is captured for later calibration. This is performed for each marker separately and consecutively. In a subsequent batch calibration step, the relative pose of the camera and the monitor are estimated.

Next, two calibration methods are provided in accordance with different aspects of the present invention. The methods depend on if the screen dimensions are known, and several options for obtaining the reference directions, i.e. the direction that the user actually points to.

The next section describes the different choices of reference directions and a subsequent section describes the two calibration methods based on the reference points, independently of which reference points have been chosen.

Contributions

The herein provided approach contains at least three contributions in accordance with various aspects of the present invention:

(1) A gesture-based way to control the calibration process.

(2) A human pose derived measurement process for screen-sensor calibration.

(3) An ‘iron-sight’ method to improve calibration performance.

Establishing the Reference Points

FIG. 11 illustrates the overall geometry of a scene. A user 900 stands in front of a screen D 901, visible from a sensor C 902 which may be at least one camera. For establishing a pointing direction, one reference point in one embodiment of the present invention is always the tip of a specific finger R_{f}, e.g. the tip of the extended index finger. It should be clear that other fixed reference points can be used, as long as they have a measure of repeatability and accuracy. For instance, a tip of a stretched thumb can be used. There are at least two options for the locations of the other reference point:

(1) The shoulder joint Rₛ: The arm of the user is pointing towards the marker. This is possibly hard to verify for the inexperienced user as there is no direct visual feedback if the pointing direction is proper. This might introduce a higher calibration error.

(2) Eyeball center Rₑ: The user is essentially performing the function of a notch-and-bead iron sight where the target on the screen can be considered the ‘bead’ and his finger can be understood as the ‘notch’. This optio-coincidence allows direct user feedback about the precision of the pointing gesture. In one embodiment of the present invention it is assumed that the side of the eye used is the same as the side of the arm used (left/right).

Sensor-Display Calibration

Method 1—Known Screen Dimensions

In the following there is no distinction between the particular choice of reference points Rₛ and Rₑ, they will be abstracted by R.

The method proceeds as follows:

1. Ensure a fixed but unknown location for (a) one or more displays, geometrically represented by oriented 2D rectangles in 3-space Dᵢ of width wᵢ and height hᵢ (b) one or more depth-sensing metric optical sensors, geometrically represented by a metric coordinate system Cⱼ.

In the following only one display D and one camera C are considered, without loss of generality.

2. Display a consecutive sequence of K visual markers with known 2D locations mₖ=(x, y)ₖ on the screen surface D.

3. For each of the K visual markers (a) Detect the location of the user's right and left hand, right and left elbow and right and left shoulder joint as well as the reference points R_{f} and R in the sensor data from sensor C in the metric 3D coordinates of camera system D, (b) Measure the right and left elbow angle as the angle between the hand, elbow and shoulder locations on either left and right side, (c) If the angle is significantly different from 180° wait for the next sensor measurement and go back to step (b) and (d) Continuously measure the angle for a pre-determined period of time.

If the angle differs significantly from 180° at any time, go back to step (b). Then (e) Record the locations of the reference points of the user for this marker. Several measurements for each marker can be recorded for robustness.

4. After the hand and head position of the user are recorded for each of the K markers, the batch calibration proceeds as follows:

(a) The screen surface D can be characterized by an origin G and two normalized directions Eₓ, E_{y}. Any point P on it can be written as:

P=G+xwEₓ+yhE_{y}, with 0≦x≦1 and 0≦y≦1.

(b) Each set of measurements (m, R_{f}, R)ₖ yields a little information about the geometry of the scene: The ray defined by the two points R_{fk} and Rₖ intersects the screen in the 3D point λₖ (Rₖ−R_{fk}). According to the measurement steps above this point is assumed to coincide with the 3D point G+xEₓ+yE_{y} on the screen surface D.

Formally,

G+xwEₓ+yhE_{y}≡λₖ(Rₖ−R_{fk}) (4)

(c) In the above equation there are 6 unknowns on the left side and one for each right side and each measurement yields three equalities. Accordingly a minimum of K=3 measurements are necessary for a total number of unknowns and a total number of equalities of 9.

(d) The set of equations (4) for the collected measurements are solved for the unknown parameters G, Eₓ, E_{y} to recover the screen surface geometry and thus a relative pose.

(e) In the case of multiple measurements for each marker or a number of markers K>3, the equations 4 can be modified to instead minimize the distance between the points:

$$min {\sum }_{k} ‖ ( G + {xwE}_{x} + {yhE}_{y} ) - λ ( {R}_{k} - {R}_{fk} ) ‖ \qquad ( 5 )$$

Method 2—Unknown Screen Dimensions

The previous method assumes that the physical dimensions w, h of the screen surface D are known. This might be an impractical assumption and the method described in this section does not require knowledge of the screen dimensions.

In the case of unknown screen dimensions, there are two additional unknowns: w, h in (4) and (5). The set of equations becomes ill-posed if all Oₖ are close together, which is the case for the setup in method 1 as the user does not move his head. In order to address this issue the system asks the user to move between displaying markers. The head position is tracked and the next marker is only shown if the head position has moved by a significant amount to ensure a stable optimization problem. As there are now two additional unknowns the minimum number of measurements is now K=4 for 12 unknowns and 12 equations. All other considerations and equations as explained earlier herein stay intact.

Radial Menus in 3D for Low-Latency Natural Menu Interaction

State of the art optical/IR camera-based limb/hand tracking systems have imminent latency in the pose detection due to the signal and processing path. In combination with a lack of immediate non-visual feedback (i.e. haptic) this slows down the users interaction speed significantly in comparison to traditional mouse/keyboard interaction. In order to mitigate this effect for menu selection tasks gesture-activated radial menus in 3D are provided as an aspect of the present invention. Radial menus operated by touch are known and are described in for instance U.S. Pat. No. 5,926,178 issued to Kurtenbach on Jul. 20, 1999 which is incorporated herein by reference. Gesture-activated radial menus in 3D are believed to be novel. In one embodiment a first gesture-activated radial menu is displayed on the 3D screen based on a user's gesture. One item in the radial menu having multiple entries is activated by a user's gesture, for instance by pointing at the item in the radial menu. An item from a radial menu may be copied from a menu by “grabbing” the item and moving it to an object. In a further embodiment an item of a radial menu is activated to a 3D object by a user pointing at the object and to the menu item. In a further embodiment of the present invention a displayed radial menu is part of a series of “staggered” menus. A user can access the different layered menus by leaving through the menus like turning pages in a book.

For the experienced user this offers virtually latency free and robust menu interaction, a critical component for natural user interfaces. The density/number of menu entries can be adapted to the user's skill starting from six entries for the novice up to 24 for the expert. Furthermore, a menu can have a layer of at least 2 menus wherein a first menu hides significantly other menus but shows 3D tabs that “unhide” the underlying menus.

Fusion of Acoustic and Visual Features for Rapid Menu Interaction

The high sampling frequency and low bandwidth of acoustic sensors offer an alternative for low-latency interaction. In accordance with an aspect of the present invention a fusing is provided of acoustic cues such as snapping of the fingers with appropriate visual cues to enable robust low-latency menu interaction. In one embodiment of the present invention a microphone array is used for spatial source disambiguation for robust multi-user scenarios.

Robust and Simple Interaction Point Detection in Hand-Based User Interaction in Consumer RGBD Sensors

In a hand-tracked interaction scenario the user's hands are continuously tracked and monitored for key gestures such as closing and opening the hand. Such gestures initiate actions depending on the current location of the hand. In typical consumer RGBD devices the low spatial sampling resolution implies that the actually tracked location on the hand depends on the overall (non-rigid) pose of the hand. In effect, during an activation gesture such as closing the hand, the position of a fixed point on the hand is difficult to separate robustly from the non-rigid deformation. Existing approaches solve this problem either by modeling and estimating the hand and fingers geometrically (which might be very imprecise for consumer RGBD sensors at typical interaction ranges and is computationally costly), or determining a fixed point on the wrist of the users (which implies further, possibly erroneous modeling of the hand and arm geometry). In contrast, the approach provided herein in accordance with an aspect of the present invention models the temporal behavior of the gesture instead. It does not rely on complex geometric models or require expensive processing. Firstly, the typical duration of the time period between the perceived initiation of the user's gesture and the time when the corresponding gesture is detected by the system is estimated. Secondly, together with a history of the tracked hand points this time period is used to establish the interaction point as the tracked hand point just before the “back-calculated” perceived time of initiation. As this process depends on the actual gesture, it can accommodate a wide range of gesture complexities/durations. Possible improvements include an adaptive mechanism, where the estimate time period between perceived and detected action initiation is determined from the actual sensor data to accommodate different gesture behaviors/speeds between different users.

Fusion of RGBD Data in Hand Classification

In accordance with an aspect of the present invention classification of open vs. closed hand is determined from RGB and depth data. This is achieved in one embodiment of the present invention by fusion of off-the-shelf classifiers trained on RGB and depth separately.

Robust Non-Intrusive User Activation and Deactivation Mechanism

Addresses the problem of determining which user from a group within the sensors range wants to interact. Detection of active user by center of mass and natural/non-intrusive attention gesture with hysteresis threshold for robustness. A certain gesture or a combination of a gesture and a gaze selects a person from a group of persons as the one in control of the 3D display. A second gesture or gesture/gaze combination gives up control of the 3D display.

Augmented Viewpoint Adaptation for 3D Display

Alignment of rendered scene camera pose to users' pose to create augmented viewpoint (e.g. 360_rotation around y-axis).

Integration of depth sensor, virtual world client and 3D visualization for natural navigation in immersive virtual environments

The term “activation” of an object such as a 3D object by the processor is used herein. Also the term “activated object” is used herein. The terms “activating”, “activation” and “activated” are used in the context of a computer interface. In general, a computer interface applies a haptic (touch based) tool, such as a mouse with buttons. A position and movement of a mouse corresponds with a position and movement of a pointer or a cursor on a computer screen. A screen in general contains a plurality of objects such as images or icons displayed on a screen. Moving a cursor with a mouse over an icon may change a color or some other property of an icon, indicating that the icon is ready for activation. Such activation may include starting a program, bringing a window related to the icon to a foreground, displaying a document or an image or any other action. Another activation of an icon or an object is the known “right click” on a mouse. In general this displays a menu of options related to the object, including “open with . . . ”; “print”: “delete”; “scan for viruses” and other menu items as are known to applications of for instance the Microsoft® Windows user's interface.

For instance, a known application such as Microsoft® “Powerpoint” a slide on a displayed in design mode may contain different objects such a circles and squares and text. One does not want to modify or move objects by merely moving a cursor over such displayed objects. In general, a user has to place a cursor over a selected object and click on a button (or tap on a touch screen) to select the object for processing. By clicking the button the object is selected and the object is now activated for further processing. Without the activation step an object can in general not be individually manipulated. An object after processing, such as resizing, moving, rotating or re-coloring or the like, is de-activated by moving the cursor away or remote from the object and clicking on the remote area.

Activating a 3D object herein is applied in a similar sense as in the above example using a mouse. A 3D object displayed on a 3D display may be de-activated. A gaze of a person using a head frame with one or two endo-cameras and an exo-camera is directed at the 3D object on the 3D display. The computer, of course, knows the coordinates of the 3D object on the screen, and in case of 3D display knows where the virtual position of the 3D object is relative to the display. The data generated by the calibrated head frame provided to the computer enables the computer to determine the direction and the coordinates of the directed gaze relative to the display and thus to match the gaze with the corresponding displayed 3D object. In one embodiment of the present invention a lingering or a focus of a gaze on the 3D object activates the 3D object, which may be an icon, for processing. In one embodiment of the present invention a further activity by the user, such as ahead movement, eye blinking or a gesture, such as pointing with a finger, is required to activate the object. In one embodiment of the present invention a gaze activates the object or icon and a further user activity is required to display a menu. In one embodiment of the present invention a gaze or a lingering gaze activates an object and a specific gesture provides the further processing of the object. For instance a gaze or a lingering gaze for a minimum time activates an object, and a hand gesture, for instance a stretched hand in a vertical plane moved from a first position to a second position moves the object on the display from a first screen position to a second screen position.

A 3D object displayed on a 3D display may change in color and/or resolution when being “gazed-over” by a user. A 3D object displayed on a 3D display in one embodiment of the present invention is de-activated by moving a gaze away from the 3D object. One may apply different processing to an object, selected from a menu or a palette of options. In that case it would be inconvenient to lose the “activation” while a user is looking at a menu. In that case an object remains activated until a user provides a specific ‘deactivation” gaze like closing both eyes or a deactivation gesture, such as a “thumb-down” gesture or any other gaze and/or gesture that is recognized by the computer as a de-activation signal. When a 3D object is de-activated it may be displayed in colors with less brightness, contrast and/or resolution.

In further applications of a graphics user interface, a mouse-over of an icon will lead to a display of one or more properties related to the object or icon.

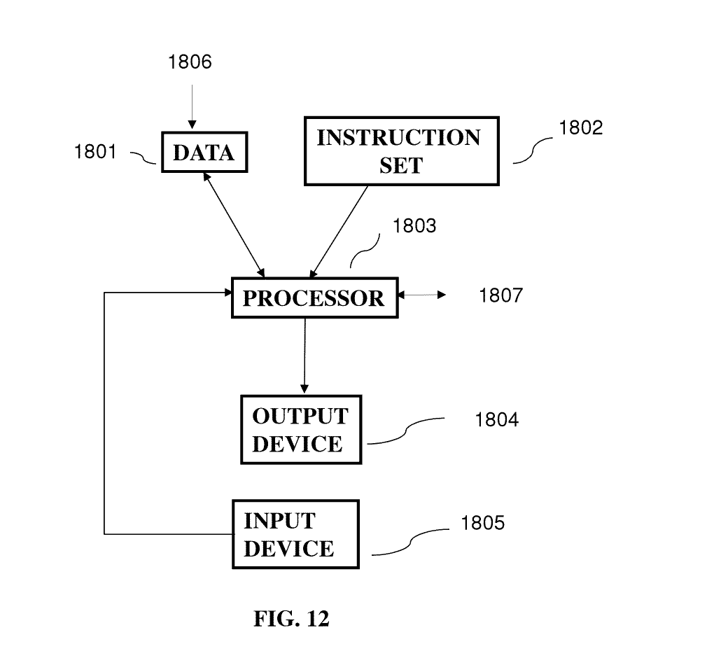

The methods as provided herein are, in one embodiment of the present invention, implemented on a system or a computer device. A system illustrated in FIG. 12 and as provided herein is enabled for receiving, processing and generating data. The system is provided with data that can be stored on a memory 1801. Data may be obtained from a sensor such as a camera which includes and one or more endo-cameras and an exo-camera or may be provided from any other data relevant source. Data may be provided on an input 1806. Such data may be image data or positional data, or CAD data, or any other data that is helpful in a vision and display system. The processor is also provided or programmed with an instruction set or program executing the methods of the present invention that is stored on a memory 1802 and is provided to the processor 1803, which executes the instructions of 1802 to process the data from 1801. Data, such as image data or any other data provided by the processor can be outputted on an output device 1804, which may be a 3D display to display 3D images or a data storage device. The output device 1804 in one embodiment of the present invention is a screen or display, preferably a 3D display, where upon the processor displays a 3D image which may be recorded by a camera and associated with coordinates in a calibrated space as defined by the methods provided as an aspect of the present invention. An image on a screen may be modified by the computer in accordance with one or more gestures from a user that are recorded by a camera. The processor also has a communication channel 1807 to receive external data from a communication device and to transmit data to an external device. The system in one embodiment of the present invention has an input device 1805, which may the head frame as described herein and which may also include a keyboard, a mouse, a pointing device, one or more cameras or any other device that can generate data to be provided to processor 1803.

The processor can be dedicated hardware. However, the processor can also be a CPU or any other computing device that can execute the instructions of 1802. Accordingly, the system as illustrated in FIG. 12 provides a system for data processing resulting from a sensor, a camera or any other data source and is enabled to execute the steps of the methods as provided herein as an aspect of the present invention.

Thus, a system and methods have been described herein for at least an Industry Gaze and Gesture Natural Interface (SIG2N).

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A method for a person wearing a head frame having a first camera aimed at an eye of the person to interact with a 3D object displayed on a display by gazing at the 3D object with the eye and by making a gesture with a body part, comprising:
sensing an image of the eye, an image of the display and an image of the gesture with at least two cameras, one of the at least two cameras being mounted in the head frame adapted to be pointed at the display and the other of the at least two cameras being the first camera;
transmitting the image of the eye, the image of the gesture and the image of the display to a processor;
the processor determining a viewing direction of the eye and a location of the head frame relative to the display from the images and then determining the 3D object the person is gazing at;
the processor recognizing the gesture from the image of the gesture out of a plurality of gestures; and
the processor further processing the 3D object based on the gaze or the gesture or the gaze and the gesture.

2. The method of claim 1, wherein the second camera is located in the head frame.

3. The method of claim 1, wherein a third camera is located either in the display or in an area adjacent to the display.

4. The method of claim 1, wherein the head frame includes a fourth camera in the head frame pointed at a second eye of the person to capture a viewing direction of the second eye.

5. The method of claim 4, further comprising the processor determining a 3D focus point from an intersection of the first eye's viewing direction and the second eye's viewing direction.

6. The method of claim 1, wherein the further processing of the 3D object includes an activation of the 3D object.

7. The method of claim 1, wherein the further processing of the 3D object includes a rendering with an increased resolution of the 3D object based on the gaze or the gesture or both the gaze and the gesture.

8. The method of claim 1, wherein the 3D object is generated by a Computer Aided Design program.

9. The method of claim 1, further comprising the processor recognizing the gesture based on the data from the second camera.

10. The method of claim 9, wherein the processor moves the 3D object on the display based on the gesture.

11. The method of claim 1, further comprising the processor determining a change in position of the person wearing the head frame to a new position and the processor re-rendering the 3D object on the computer 3D display corresponding to the new position.

12. The method of claim 11, wherein the processor determines the change in position and re-renders at a frame rate of the display.

13. The method of claim 11, further comprising the processor generating information for display related to the 3D object being gazed at.

14. The method of claim 1, wherein the further processing of the 3D object includes an activation of a radial menu related to the 3D object.

15. The method of claim 1, wherein further processing of the 3D object includes an activation of a plurality of radial menus stacked on top of each other in 3D space.

16. The method of claim 1, further comprising:
the processor calibrating a relative pose of a hand and arm gesture of the person pointing at an area on the 3D computer display;
the person pointing at the 3D computer display in a new pose; and
the processor estimating coordinates related to the new pose based on the calibrated relative pose.

17. A system wherein a person interacts with one or more or a plurality of 3D objects through a gaze with a first eye and through a gesture by a body part, comprising:
a computer display that displays the plurality of 3D objects;
a head frame containing a first camera adapted to point at the first eye of the person wearing the head frame and a second camera adapted to point to an area of the computer display and to capture the gesture;
a processor, enabled to execute instructions to perform the steps:
receiving data transmitted by the first and second cameras;
processing the received data to determine a 3D object in the plurality of objects where the gaze is directed at;
processing the received data to recognize the gesture from a plurality of gestures; and
further processing the 3D object based on the gaze and gesture.

18. The system of claim 17, wherein the computer display displays a 3D image.

19. The system of claim 17, wherein the display is part of a stereoscopic viewing system.

20. A device with which a person interacts with a 3D object displayed on a 3D computer display through a gaze from a first eye and a gaze from a second eye and through a gesture by a body part of the person, comprising:
a frame adapted to be worn by the person;
a first camera mounted in the frame adapted to point at the first eye to capture the first gaze,
a second camera mounted in the frame adapted to point at the second eye to capture the second gaze,
a third camera mounted in the frame adapted to point at the 3D computer display and to capture the gesture,
a first and a second glass mounted in the frame such that the first eye looks through the first glass and the second eye looks through the second glass, the first and second glasses acting as 3D viewing shutters; and
a transmitter to transmit data generated by the cameras.
